(19) United States
(12) Patent Application Publication
(10) Pub. No.: US 2014/0140801 A1
(43) Pub. Date: May 22, 2014

(54) SUBSTRATE TRANSFER ROBOT AND SUBSTRATE TRANSFER METHOD

(71) Applicant: KABUSHIKI KAISHA YASKAWA DENKI, Kitakyushu-shi (JP)

(72) Inventors: Satoshi SUEYOSHI, Fukuoka (JP); Makoto TARUNO, Fukuoka (JP)

(73) Assignee: KABUSHIKI KAISHA YASKAWA DENKI, Kitakyushu-shi (JP)

(21) Appl. No.: 14/050,360

(22) Filed: Oct. 10, 2013

(30) Foreign Application Priority Data
Nov. 16, 2012 (JP) 2012-252390

(51) Int. Cl. B25J 11/00

(52) U.S. Cl. CPC B25J 11/0095
USPC 414/744.6; 414/800

(57) ABSTRACT

A substrate transfer robot includes an extensible/retractable arm unit, a robot hand and a sensor unit. The extensible/retractable arm unit is configured to extend and retract in a horizontal direction. The robot hand is provided with prongs for holding a substrate. The robot hand includes a base end portion rotatably connected to a tip end portion of the extensible/retractable arm unit. The sensor unit is arranged to be rotated by a rotating force of the robot hand. The sensor unit is configured to, when rotated, intersect a lateral end portion of the substrate held by the prongs when seen in a plan view and to detect a lateral end position of the substrate.

### CROSS-REFERENCE TO RELATED APPLICATION

The present disclosure contains subject matter related to that disclosed in Japanese Priority Patent Application No. 2012-252390 filed on Nov. 16, 2012. The contents of this application are incorporated herein by reference in their entirety.

### BACKGROUND OF THE INVENTION

1. Field of the Invention

An embodiment disclosed herein relates to a substrate transfer robot and a substrate transfer method.

2. Description of the Related Art

Conventionally, there is known a substrate transfer robot that takes out a thin plate-shaped substrate such as a glass substrate or a semiconductor wafer from a cassette as a substrate receiving container and transfers the substrate to a predetermined transfer location. The substrate transfer robot is often formed of a so-called horizontal articulated robot.

The horizontal articulated robot is a robot provided with an extensible/retractable arm unit in which two arms are connected through a joint. A robot hand (hereinafter just referred to as “hand”) installed at the tip end portion of the extensible/retractable arm unit is linearly moved by causing each of the arms to make a rotating operation.

In the substrate transfer robot, the hand is provided with a substrate holding member such as a fork or the like. The substrate transfer robot linearly moves the substrate holding member by virtue of the aforementioned linear movement of the hand and causes the substrate holding member to enter a cassette. The substrate holding member holds a substrate by lifting up the same from below. By retracting an extensible/retractable arm unit, the substrate transfer robot linearly takes out the substrate from the cassette.

It is sometimes the case that the substrate is accommodated within the cassette at a location deviated from a normal position. For that reason, it is demanded in the substrate transfer robot that the substrate be transferred to a right position while correcting the positional deviation. In order to comply with this demand, there have been made different kinds of proposals.

As one example, there has been proposed a hand position aligning method and device in which the positional deviation of the substrate is corrected by detecting the rear edge of the substrate with a first sensor installed in the root portion of a fork and detecting the left edge of the substrate with a second sensor installed in a salient portion protruding leftward from the fork.

In case of the above proposal, however, the fork is highly likely to interfere with the cassette because the salient portion inevitably enter the cassette. Since the salient portion is formed in a fixed position, there may be a case where, depending on the deviated pattern of the substrate, the lateral edge of the substrate cannot be detected by the second sensor installed in the salient portion.

Under the circumstances, the applicant of the subject application has proposed in, e.g., Japanese Patent No. 4766233, a substrate transfer robot in which an arm provided with a sensor is installed in a frame of a hand and in which the position of a substrate is detected by swinging the arm outside a cassette.

This makes it possible to prevent the hand from interfering with the cassette. Moreover, it is possible to enhance the reliability of position detection because rotation detection is performed by the sensor. In the substrate transfer robot disclosed in Japanese Patent No. 4766233, the arm provided with the sensor is swingably driven by an independent drive power source.

In the aforementioned related art, however, there is a room for further improvement in terms of cost-effectiveness. More specifically, since the arm provided with the sensor is driven by the independent drive power source in the aforementioned prior art, it is necessary to employ the drive power source, a speed reducer and the like. Thus the cost is likely to increase.

Moreover, the hand is likely to become heavyweight due to the use of the drive power source, the speed reducer and the like. In recent years, the chance of transferring large substrates tends to increase. Consequently, it may sometimes difficult to maintain the substrate position detection accuracy due to transverse sway or other causes.

### SUMMARY OF THE INVENTION

In accordance with a first aspect of the embodiment, there is provided a substrate transfer robot, including: an extensible/retractable arm unit configured to extend and retract in a horizontal direction; a robot hand provided with prongs for holding a substrate, the robot hand including a base end portion rotatably connected to a tip end portion of the extensible/retractable arm unit; and a sensor unit arranged to be rotated by a rotating force of the robot hand, the sensor unit configured to, when rotated, intersect a lateral end portion of the substrate held by the prongs when seen in a plan view and to detect a lateral end position of the substrate.

### BRIEF DESCRIPTION OF THE DRAWINGS

FIG. 1 is a schematic diagram showing the schematic configuration of a robot according to an embodiment.

FIG. 2A is a schematic plan view showing a state in which an extensible/retractable arm unit of the robot is most retracted.

FIG. 2B is a schematic plan view showing a state in which the extensible/retractable arm unit of the robot is extended.

FIG. 3A is a schematic plan view showing a rotation structure of a sensor unit.

FIG. 3B is a schematic front view showing the rotation structure of the sensor unit.

FIG. 3C is a schematic side view showing the rotation structure of the sensor unit.

FIGS. 4A to 4D are schematic diagrams illustrating a workpiece transfer method.

FIG. 5 is a view explaining a method of calculating a workpiece deviation amount.

FIGS. 6A and 6B are schematic plan views showing the configuration of a hand according to a first modified example.

FIGS. 7A and 7B are schematic plan views showing the configuration of a hand according to a second modified example.

### DESCRIPTION OF THE EMBODIMENTS

An embodiment of a substrate transfer robot and a substrate transfer method disclosed in the subject application will now be described in detail with reference to the accompanying drawings which form a part hereof. The present disclosure is not limited by the embodiment described herein below.

In the following description, a substrate transfer robot for transferring a glass substrate as a transfer target object will be described by way of example. The substrate transfer robot will be just referred to as “robot”. A robot hand as an end effector will be just referred to as “hand”. The glass substrate will be referred to as “workpiece”.

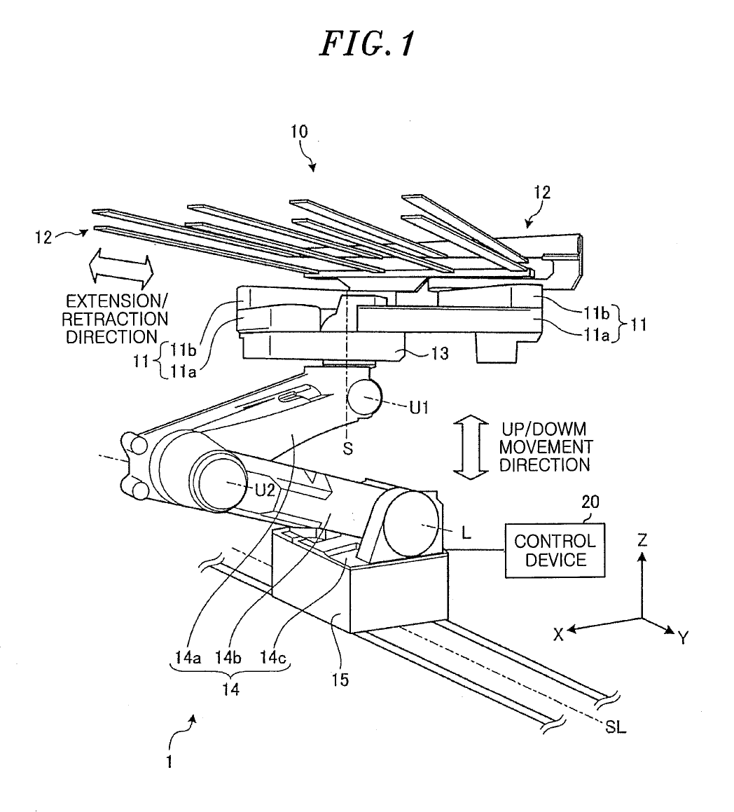

First, the configuration of a robot 10 according to an embodiment will be described with reference to FIG. 1. FIG. 1 is a schematic diagram showing the schematic configuration of the robot 10 according to the present embodiment.

For the sake of making the description easily understandable, FIG. 1 indicates a three-dimensional rectangular coordinate system including a Z-axis whose positive direction is a vertical upward direction and whose negative direction is a vertical downward direction. The direction parallel to an XY plane designates a “horizontal direction”. The rectangular coordinate system will be sometimes indicated in other drawings used in the following description. In the following description, the X-axis positive direction will be defined as “front” and the Y-axis positive direction will be defined as “left”.

In the following description, it is sometimes the case that, if there exists a plurality of components, only a part of the components is designated by a reference symbol with the remaining components not designated by reference symbols. In this case, the component designated by a reference symbol is identical in configuration with the remaining components not designated by reference symbols.

The robot 10 shown in FIG. 1 is a dual-arm horizontal articulated robot including a pair of extensible/retractable arm units 11 which can be extended and retracted in an extension/retraction direction, i.e., in an X-axis direction. More specifically, the robot 11 includes a pair of extensible/retractable arm units 11, a pair of hands 12, an arm base 13, an elevating stand 14 and a running table 15.

Each of the extensible/retractable arm units 11 includes a first arm 11a and a second arm 11b. The elevating stand 14 includes a first elevator arm 14a, a second elevator arm 14b and a base portion 14c.

Each of the hands 12 is an end effector installed in the tip end portion of each of the extensible/retractable arm units 11. The arm base 13 is a base portion of the extensible/retractable arm units 11 and is configured to horizontally rotatably support the extensible/retractable arm units 11.

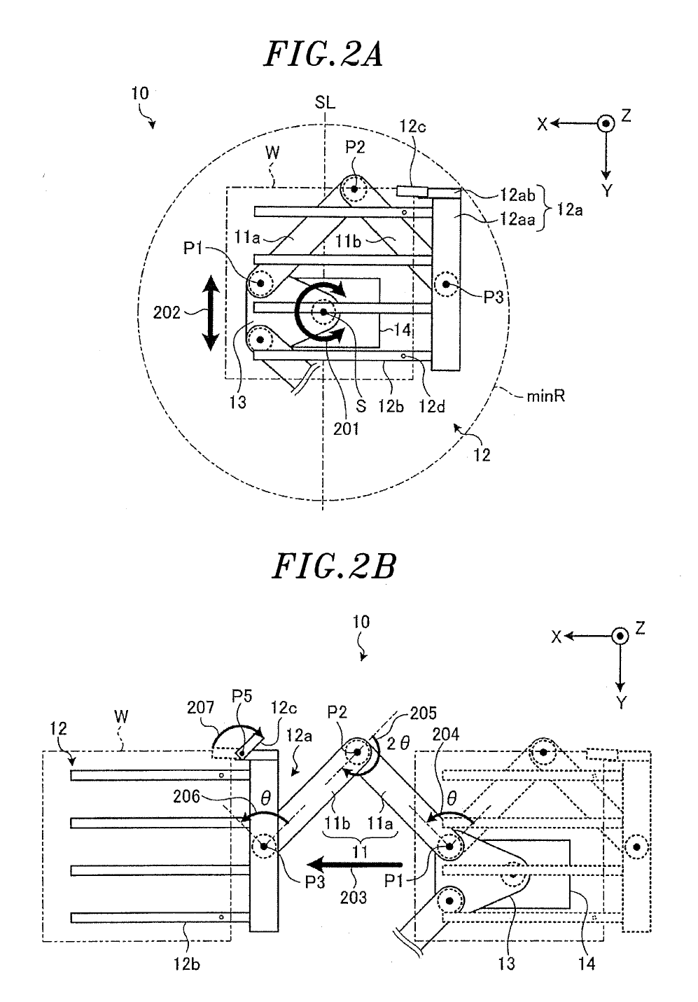

Details of the extensible/retractable arm units 11, the hand 12 and the arm base 13 will be described later with reference to FIG. 2A and subsequent figures.

The arm base 13 is installed to swing with respect to the elevating stand 14 about a swing axis S parallel to the vertical direction. In the following description, the swing operation about the swing axis S will be sometimes referred to as “swing axis operation” of the robot 10.

The elevating stand 14 is a unit that swingably supports the arm base 13 in the tip end portion thereof and moves the arm base 13 up and down along an up/down movement direction parallel to the vertical direction.

The first elevator arm 14a supports the arm base 13 in the tip end portion thereof so that the arm base 13 can swing about the swing axis S and can rotate about an axis U1. The second elevator arm 14b supports the base end portion of the first elevator arm 14a in the tip end portion thereof so that the first elevator arm 14a can rotate about an axis U2.

The base portion 14c is installed on the running table 15 to support the base end portion of the second elevator arm 14b so that the second elevator arm 14b can rotate about an axis L. The running table 15 is a running mechanism formed of a running carriage or the like. The running table 15 runs along, e.g., a running axis SL parallel to a Y-axis in FIG. 1. The running axis SL is not limited an axis having a linear shape. In the following description, the running operation along the running axis SL will be sometimes referred to as “running axis operation” of the robot 10.

The robot 10 performs an up/down operation by rotating the arm base 13 about the axis U1, the first elevator arm 14a about the axis U2, and the second elevator arm 14b about the axis L.

A control device 20 is connected to the robot 10 so as to make mutual communication with the robot 10. The control device 20 performs operation control to enable the robot 10 to carry out different kinds of operations, such as the aforementioned up/down operation, the aforementioned swing axis operation, the aforementioned running axis operation and the below-mentioned extension/retraction operation of the extensible/retractable arm units 11. A substrate transfer system 1 is configured to include at least the control device 20 and the robot 10.

Next, the configuration existing above the arm base 13 will be mainly described with reference to FIGS. 2A and 2B which illustrates the robot 10 seen in a plan view. FIG. 2A is a schematic plan view showing a state in which the extensible/retractable arm units 11 of the robot 10 is most retracted. FIG. 2B is a schematic plan view showing a state in which the extensible/retractable arm units 11 of the robot 10 is extended.

For the sake of making the description easily understandable, only one of the extensible/retractable arm units 11 installed as dual arms, i.e., the extensible/retractable arm unit 11 corresponding to a right arm, will be shown and described herein below.

As shown in FIG. 2A, the base end portion of the first arm 11a is connected to the arm base 13 so that the first arm 11a can rotate about an axis P1. The base end portion of the second arm 11b is connected to the tip end portion of the first arm 11a so that the second arm 11b can rotate about an axis P2.

The base end portion of the hand 12 is connected to the tip end portion of the second arm 11b so that the hand can rotate about an axis P3. The hand 12 includes a frame 12a, a plurality of prongs 12b, a sensor unit 12c and rotational deviation sensors 12d. The frame 12a is connected to the second arm 11b.

The frame 12a includes a base frame 12aa and a sensor support frame 12ab. The base frame 12aa supports the prongs 12b in parallel. The sensor support frame 12ab rotatably supports the base end portion of the sensor unit 12c.

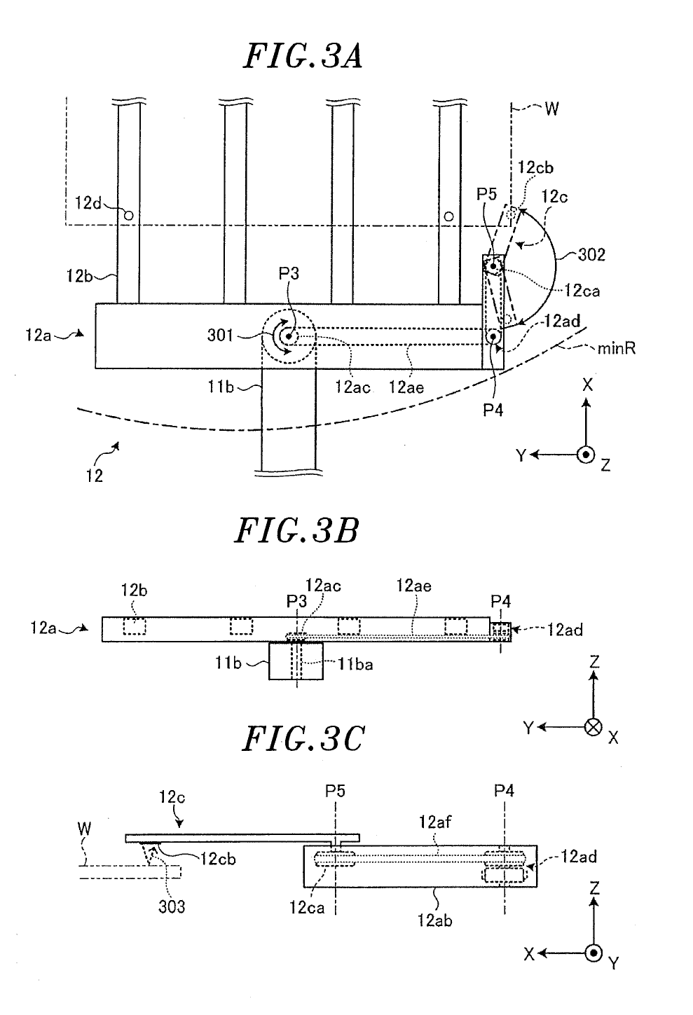

The frame 12a has a hollow structure. Different kinds of members such as a pulley and a belt, which will be described later, are arranged within the frame 12a. On this point, description will be made later in more detail with reference to FIGS. 3A, 3B and 3C.

As shown in FIG. 2A, the prongs 12b are members for holding a workpiece W and is configured to hold the workpiece W by, e.g., supporting the workpiece W on the major surfaces thereof. The method of holding the workpiece W is not limited to the supporting method. As an alternative example, the prongs 12b may suck the workpiece W from above. In the present embodiment, it is assumed that the workpiece W is supported on the prongs 12b.

The sensor unit 12c is a detection unit for detecting a lateral end position of the workpiece W held by the prongs 12b. The sensor unit 12c is formed of, e.g., an optical beam sensor unit having a light emitting/receiving portion 12cb (which will be described later). The sensor unit 12c is not limited to an optical type but may be a magnetic type, an electrostatic type or an ultrasonic type. In the present embodiment, it is assumed that the sensor unit 12c is an optical type.

The sensor unit 12c is rotatably connected to the sensor support frame 12ab (namely, the frame 12a) in the base end portion thereof. In the tip end portion of the sensor unit 12c, the light emitting/receiving portion 12cb is arranged so as to form an optical axis downward, namely toward the upper surface of the workpiece W.

If the base end portion of the sensor unit 12c is rotated with respect to the frame 12a, the light emitting/receiving portion 12cb existing at the tip end portion of the sensor unit 12c intersects the lateral end portion of the workpiece W when seen in a plan view. Thus the sensor unit 12c detects the lateral end position of the workpiece W.

The rotation of the sensor unit 12c is passively performed by the rotating force of the hand 12 rotating about the axis P3. Accordingly, the sensor unit 12c does not require an independent drive power source for rotationally driving the sensor unit 12c per se.

As shown in FIG. 2A, when the extensible/retractable arm unit 11 is kept in a retracted state, the sensor unit 12c is rotated such that the tip end portion thereof faces the workpiece W. The rotation mechanism of the sensor unit 12c including this point will be described later in more detail with reference to FIGS. 3A, 3B and 3C.

As illustrated in FIG. 2A, the rotational deviation sensors 12d are units for detecting the rotational deviation of the workpiece W. The rotational deviation sensors 12d are respectively arranged, e.g., in the vicinity of the base end portions of the opposite end prongs 12b. In the present embodiment, the term “rotational deviation” is intended to include the deviation of the workpiece W in the front-rear direction extending along the X-axis.

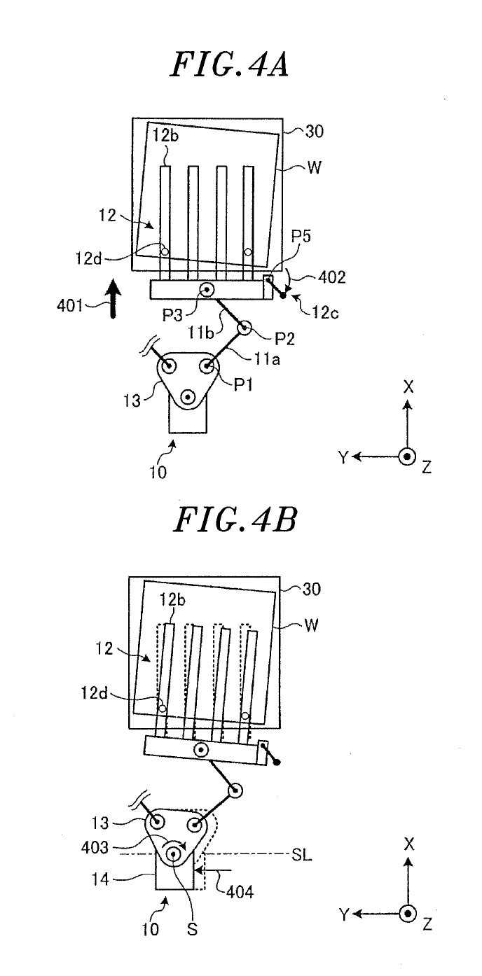

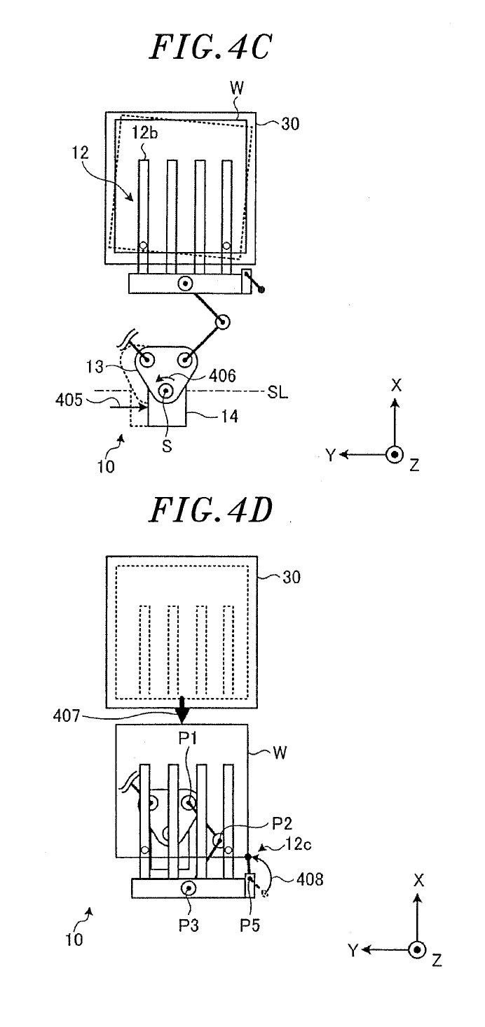

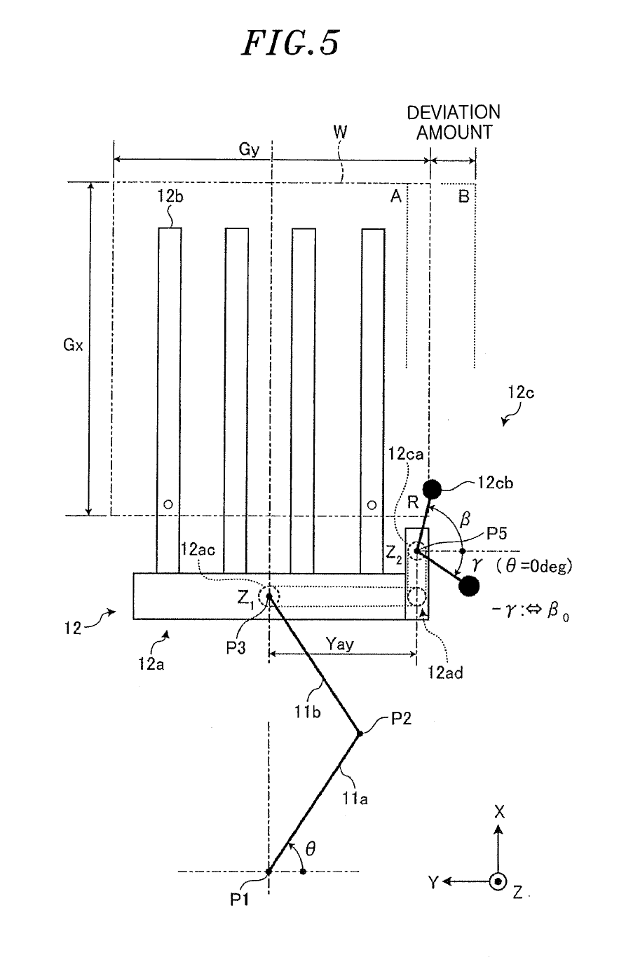

The role of the rotational deviation sensors 12d will be described later with reference to FIGS. 4A through 4D. In the present embodiment, the rotational deviation sensors 12d are optical type sensors just like the sensor unit 12c and are arranged to form optical axes upward, namely toward the lower surface of the workpiece W.

As already described in respect of FIG. 1 and as illustrated in FIG. 2A, the robot 10 can perform the swing axis operation about the swing axis S (see a double-headed arrow 201 in FIG. 2A) and the running axis operation along the running axis SL (see a double-headed arrow 202 in FIG. 2A).

The circle minR depicted in FIG. 2A is a trajectory described by the base end portion of the frame 12a when the swing axis operation is performed with the extensible/retractable arm unit 11 kept in a most retracted state, namely a “minimum swing radius”.

As shown in FIG. 2B, when extending the extensible/retractable arm unit 11 (see an arrow 203 in FIG. 2B), the robot 10 performs an operation of extending the extensible/retractable arm unit 11 while restricting the moving direction and the orientation of the hand 12 to a specified moving direction and a specified orientation (to the X-axis positive direction in FIG. 2B).

More specifically, when extending the extensible/retractable arm unit 11, the robot 10 rotates the first arm 11a counterclockwise by a rotation amount θ about the axis P1 (see an arrow 204 in FIG. 2B). At this time, the second arm 11b is rotated clockwise by a double rotation amount 20 about the axis P2 with respect to the first arm 11a (see an arrow 205 in FIG. 2B).

The hand 12 is rotated counterclockwise by a rotation amount θ about the axis P3 with respect to the second arm 11b (see an arrow 206 in FIG. 2B). As a result, the extensible/retractable arm unit 11 can be extended while keeping the moving direction of the hand 12 to the direction linearly extending along the X-axis and keeping the orientation of the hand 12 (namely, the orientation of the tip end portions of the prongs 12b) to the front side.

At this time, the sensor unit 12c rotates clockwise about an axis P5 with respect to the frame 12a of the hand (see an arrow 207 in FIG. 2B) such that the tip end portion of the sensor unit 12c faces rearward (namely, toward the base end portion of the hand 12). Accordingly, when the hand 12 enters a cassette in order to take out the workpiece W, it is possible to prevent the sensor unit 12c from interfering with the cassette.

When retracting the extensible/retractable arm unit 11, the rotation directions about the axes P1, P2, P3 and P5 are opposite to the rotation directions available when extending the extensible/retractable arm unit 11. In the course of retracting the extensible/retractable arm unit 11, the sensor unit 12c intersects the lateral end portion of the workpiece W when seen in a plan view. Thus, the sensor unit 12c can detect the lateral end position of the workpiece W.

In other words, the second arm 11b rotates in the direction opposite to the rotating direction of the first arm 11a by a rotation amount 20 twice as large as the rotation amount θ of the first arm 11a. The hand 12 rotates in the direction opposite to the rotating direction of the second arm 11b by a rotation amount θ. Thus, the robot 10 extends and retracts while maintaining the orientation of the hand 12 in a predetermined orientation. In a state that the extensible/retractable arm unit 11 is extended, the tip end portion of the sensor unit 12c is escaped toward the base end portion of the hand 12. When the extensible/retractable arm unit 11 is kept in a retracted state, the sensor unit 12c makes arc-like rotation so that the tip end portion thereof can intersect the lateral end portion of the workpiece W.

Next, the rotation structure of the sensor unit 12c will be described with reference to FIGS. 3A, 3B and 3C. FIG. 3A is a schematic plan view showing the rotation structure of the sensor unit 12c. FIG. 3B is a schematic front view showing the rotation structure of the sensor unit 12c. FIG. 3C is a schematic side view showing the rotation structure of the sensor unit 12c. In FIGS. 3A, 3B and 3C, there are shown only the members required in description. FIG. 3C is depicted on a slightly enlarged scale.

As shown in FIG. 3A, a pulley 12ac rotating about the axis P3 (see a double-headed arrow 301 in FIG. 3A) and an intermediate pulley 12ad rotating about the axis P4 are arranged within the frame 12a.

As mentioned above, the base end portion of the sensor unit 12c is connected the frame 12a so that the sensor unit 12c can rotate about the axis P5 (see a double-headed arrow 302 in FIG. 3A). A driven pulley 12ca is installed in the base end portion of the sensor unit 12c. The sensor unit 12c is provided with a light emitting/receiving portion 12cb on the tip end portion thereof.

The pulley 12ac and the intermediate pulley 12ad are connected to each other by a belt 12ae. As shown in FIG. 3B, the pulley 12ac is installed upright from the inside of the second arm 11b and is arranged at the tip end portion of a post 11ba inserted through the frame 12a. Thus, when the hand 12 rotates with respect to the second arm 11b, the pulley 12ac makes rotation relative to the hand 12.

The rotating force generated by the relative rotation of the pulley 12ac is transmitted to the intermediate pulley 12ad via the belt 12ae. As shown in FIG. 3C, the intermediate pulley 12ad and the driven pulley 12ca are connected to each other by a belt 12af.

The rotating force transmitted to the intermediate pulley 12ad is used to rotate the driven pulley 12ca through the belt 12af and to rotate the sensor unit 12c about the axis P5. That is to say, the sensor unit 12c rotates in response to the rotation of the hand 12. In other words, since the driven pulley 12ca receives the rotating force transmitted through the belts 12ae and 12af, the sensor unit 12c rotates in response to the rotation of the hand 12 when the hand 12 makes rotation with respect to the extensible/retractable arm unit 11.

Thus, the sensor unit 12c can rotate without having to use an independent drive power source and can detect the lateral end position of the workpiece W as the light emitting/receiving portion 12cb senses the cutoff of the optical axis 303 caused by the lateral end portion of the workpiece W. It is therefore possible to make the cost-effectiveness compatible with the securing of the detection accuracy of the position of the workpiece W.

Elimination of the independent drive power source makes it possible to reduce the weight of the hand 12. Accordingly, it is possible to reduce the causes of transverse sway attributable to the hand 12 becoming heavyweight. This can assist in securing the detection accuracy of the position of the workpiece W.

The pulley 12ac, the intermediate pulley 12ad and the driven pulley 12ca are configured to have a predetermined pulley ratio which restricts the rotation amount of the sensor unit 12c. In other words, the predetermined pulley ratio is decided in advance so that, in the course of retracting the extensible/retractable arm unit 11, the sensor unit 12c can be rotated to reliably intersect the lateral end portion of the workpiece W and the sensor unit 12c should not interfere with other members.

In respect of the pulley ratio, as shown in FIG. 3A, the length of the sensor unit 12c is preferably decided to ensure that the sensor unit 12c rotates inside the circle minR as a minimum swing radius. This makes it possible to prevent the sensor unit 12c from unnecessarily interfering with other members. It is therefore possible to secure the detection accuracy of the position of the workpiece W.

Next, a method of transferring a workpiece W according to the present embodiment will be described with reference to FIGS. 4A through 4D. FIGS. 4A through 4D are schematic diagrams illustrating a method of transferring a workpiece W. Individual units and members are extremely schematically shown in FIGS. 4A through 4D.

First, the workpiece W is taken out from a cassette 30. In this case, as shown in FIG. 4A, the robot 10 causes the hand 12 to enter the cassette 30 in the direction parallel to the X-axis (see an arrow 401 shown in FIG. 4A), thereby positioning the prongs 12b below the workpiece W as a transfer target object.

At this time, the sensor unit 12c rotates about the axis P5 (see an arrow 402 in FIG. 4A) so that the tip end portion thereof can face rearward. Then, the robot 10 causes the rotational deviation sensors 12d to detect the rotational deviation of the workpiece W within the cassette 30.

The rotational deviation sensors 12d are optical sensors arranged at two left and right points of the hand 12, e.g., in the opposite end prongs 12b as illustrated in FIG. 4A. The rotational deviation sensors 12d are configured to form optical axes upward. When the hand 12 moves to below the workpiece W contained within the cassette 30, the rotational deviation sensors 12d sense the lateral end portion of the workpiece W one after another, consequently detecting the rotational deviation of the workpiece W, namely how much the workpiece W is deviated with respect to the hand 12 in the θ direction.

In this regard, it is presumed that the rotational deviation of the workpiece W has been detected by the rotational deviation sensors 12d. In this case, as shown in FIG. 4B, the robot 10 performs the swing axis operation about the swing axis S (see an arrow 403 in FIG. 4B) and the running axis operation along the running axis SL (see an arrow 404 in FIG. 4B) in proportion to the rotational deviation, thereby correcting the position of the prongs 12b with respect to the workpiece W.

By virtue of the operation of the elevating stand 14, the hand 12 is moved upward to lift up the workpiece W with the prongs 12b. Thus the workpiece W is placed on, and held by, the prongs 12b.

Subsequently, as shown in FIG. 4C, the robot 10 performs the running axis operation (see an arrow 405 in FIG. 4C) and the swing axis operation (see an arrow 406 in FIG. 4C) so that the lateral end portion of the workpiece W can become parallel to the sidewall of the cassette 30.

Then, as shown in FIG. 4D, the robot 10 performs an operation of retracting the extensible/retractable arm unit 11, thereby taking out the workpiece W from the cassette 30 (see an arrow 407 in FIG. 4D). When taking out the workpiece W, the sensor unit 12c rotates in response to the rotation of the hand 12 about the axis P3. Thus, the tip end portion of the sensor unit 12c faces frontward. The sensor unit 12c intersects the lateral end portion of the workpiece W and detects the lateral end position of the workpiece W (see an arrow 408 in FIG. 4D).

During the time period between the time at which the lateral end position of the workpiece W is detected by the sensor unit 12c and the time at which the workpiece W is transferred to a transfer destination, the robot 10 calculates the deviation amount of the workpiece W based on the detected lateral end position. This calculation may be performed by the control device 20.

Referring now to FIG. 5, description will be made on a method of calculating the deviation amount of the workpiece W. FIG. 5 is a view explaining a method of calculating the deviation amount of the workpiece W. As shown in FIG. 5, the X-axis direction length of the workpiece W is assumed to be “Gx” and the Y-axis direction length of the workpiece W is assumed to be “Gy”. The normal position of the workpiece W is designated by “Gy/2”.

The Y-axis direction distance between the center of the pulley 12ac and the center of the driven pulley 12ca is assumed to be “Yay”. The number of teeth of the pulley 12ac is assumed to be “Z₁”. The number of teeth of the driven pulley 12ca is assumed to be “Z₂”. The length of the sensor unit 12c is assumed to be “R”.

The rotation amount of the sensor unit 12c with respect to the rotation amount θ about the axis P1 is assumed to be “β”. As shown in FIG. 5, the angle when the rotation amount θ is equal to 0 degree is assumed to be “γ”. −γ is defined as “β₀”.

The correction value of the Yay is assumed to be “ΔY”, the correction value of the R is assumed to be “ΔR”, and the detection delay correction value is assumed to be “Δφ”.

In this case, the Y-axis direction deviation amount of the lateral end position of the workpiece W can be calculated by the following equation (1):

the deviation amount of the workpiece

W=Gy/2−(Yay+ΔY)+(R+ΔR)×cos{(β₀+(Z₁/Z₂)θ+Δφ)} (1).

If the deviation amount of the workpiece W is larger than 0, the deviation occurs at the side of A in FIG. 5. If the deviation amount of the workpiece W is smaller than 0, the deviation occurs at the side of B in FIG. 5.

Then, the robot 10 releases the workpiece W by, e.g., placing the workpiece W in a target position of a transfer destination while correcting the position of the workpiece W pursuant to the calculated deviation amount of the workpiece W.

While there has been described by way of example a case where the sensor unit 12c mainly detects a unidirectional (X-direction) deviation, the sensor unit 12c may detect bidirectional (X- and Y-direction) deviations.

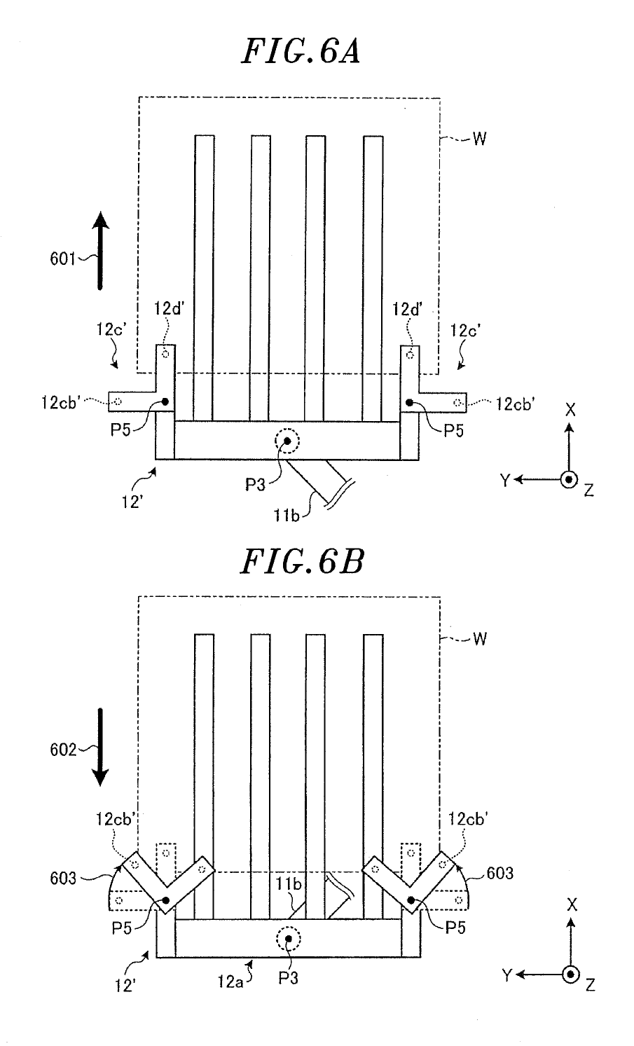

This case is regarded as a first modified example and will be described with reference to FIGS. 6A and 6B. FIGS. 6A and 6B are schematic plan views showing the configuration of a hand 12′ according to a first modified example.

As shown in FIGS. 6A and 6B, the hand 12′ according to the first modified example includes a pair of bifurcated sensor units 12c′ arranged to rotate about axes P5 in response to the rotation of the hand 12′. A first sensor 12d′ is installed in one of the tip end portions of each of the bifurcated sensor units 12c′. A second sensor 12cb′ is installed in the other tip end portion of each of the bifurcated sensor units 12c′.

If the hand 12′ is inserted into the cassette 30 as indicated by an arrow 601 in FIG. 6A and if the hand 12′ is positioned below the workpiece W as a transfer target object, the first sensor 12d′ detects the rotational deviation of the workpiece W just like the rotational deviation sensors 12d described above. Then the rotational deviation is corrected.

If the workpiece W is taken out from the cassette 30 as shown in FIG. 6B (see an arrow 602 in FIG. 6B), each of the sensor units 12c′ rotates in response to the rotation of the hand 12′ (see an arrow 603 in FIG. 6B). Thus the second sensor 12cb′ intersects the lateral end portion of the workpiece W and detects the lateral end position of the workpiece W.

Then, a deviation amount is calculated based on the detected lateral end position. The position of the workpiece W is corrected pursuant to the calculated deviation amount. Subsequently, the workpiece W is released in a target position of a transfer destination.

According to the first modified example, it is possible to make the cost-effectiveness compatible with the securing of the detection accuracy of the position of the workpiece W.

In case where the workpiece W is taken out as shown in FIG. 6B, the second sensor 12cb′ may detect the Y-axis direction lateral end position of the workpiece W. In addition, the first sensor 12d′ may detect again the X-axis direction lateral end position of the workpiece W.

In this case, the lateral end position can be detected at four points. It is therefore possible to enhance the detection accuracy of the position of the workpiece W.

In FIGS. 6A and 6B, there is illustrated an example in which each of the sensor units 12c′ has a substantially L-like shape when seen in a plan view. However, this is nothing more than one example. In reality, each of the sensor units 12c′ may have an optimal shape with the spreading degree and length thereof decided so as to avoid interference with the cassette 30 or other members.

While there has been described by way of example a case where at least two rotational deviation detecting sensors are provided, it may be possible to use a single rotational deviation detecting sensor. In this case, the sensor unit 12c may serve as the rotational deviation detecting sensor.

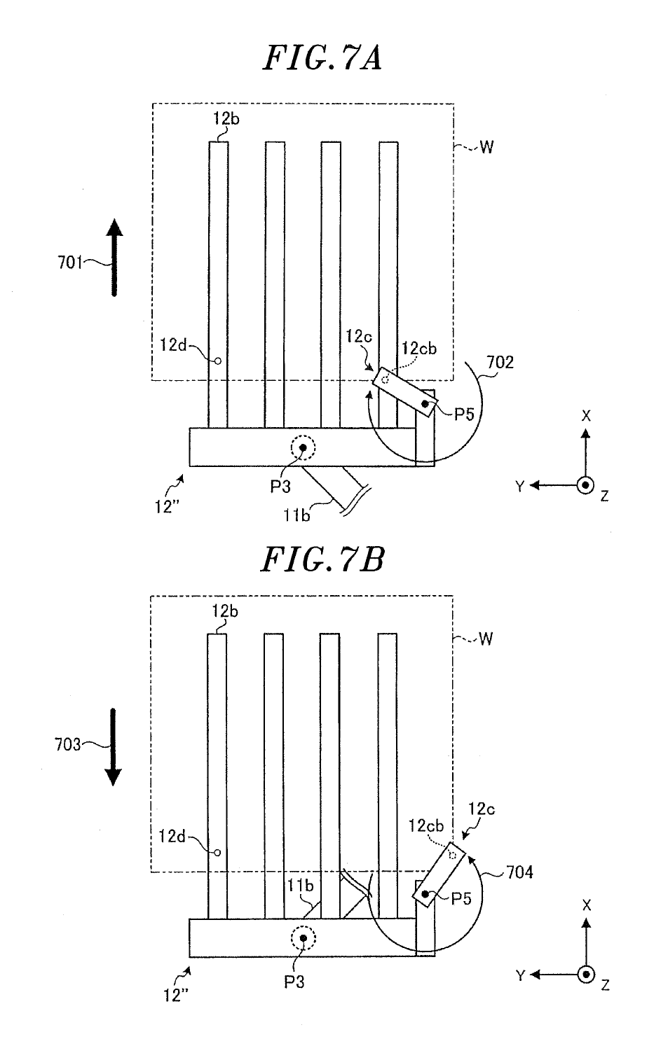

This case is regarded as a second modified example and will be described with reference to FIGS. 7A and 7B. FIGS. 7A and 7B are schematic plan views showing the configuration of a hand 12″ according to a second modified example.

As shown in FIGS. 7A and 7B, the hand 12″ according to the second modified example includes one rotational deviation sensor 12d arranged in the left end prong 12b.

If the hand 12″ is inserted below the workpiece W contained in the cassette 30 as indicated by an arrow 701 in FIG. 7A, the sensor unit 12c rotates clockwise around the base end portion of the hand 12″ when seen in a plan view, thereby causing the light emitting/receiving portion 12cb to intersect the front lateral end portion of the workpiece W. Thus the sensor unit 12c first detects the front lateral end position of the workpiece W (see an arrow 702 in FIG. 7A).

The rotational deviation of the workpiece W is detected based on the detection result of the sensor unit 12c and the detection result of the rotational deviation sensor 12d arranged in the prong 12b. Then the rotational deviation of the workpiece W is corrected.

If the workpiece W is taken out from the cassette 30 as indicated by an arrow 703 in FIG. 7B, the sensor unit 12c rotates counterclockwise around the base end portion of the hand 12″ when seen in a plan view, thereby causing the light emitting/receiving portion 12cb to intersect the right lateral end portion of the workpiece W. Then, the sensor unit 12c detects the right lateral end position of the workpiece W (see an arrow 704 in FIG. 7B).

Subsequently, a Y-axis direction deviation amount is calculated based on the detected lateral end positions. The position of the workpiece W is corrected pursuant to the calculated deviation amount. Thereafter, the workpiece W is released in a target position of a transfer destination.

The rotating operation of the sensor unit 12c can be easily realized by changing, e.g., the number “Z₁” of teeth of the pulley 12ac and the number “Z₂” of teeth of the driven pulley 12ca, which makes up the predetermined pulley ratio mentioned above. Moreover, it is sufficient to use a single rotational deviation sensor 12d. This assists in achieving cost-effectiveness.

According to the second modified example, it is possible to make the cost-effectiveness compatible with the securing of the detection accuracy of the position of the workpiece W.

In FIGS. 7A and 7B, there is illustrated a case where the rotational deviation sensors 12d is arranged in the left end prong 12b and the sensor unit 12c is arranged adjacent to the right end prong 12b. However, the arrangement positions of the rotational deviation sensors 12d and the sensor unit 12c may be reversed. In other words, the sensor unit 12c may be configured to make arc-like rotation so that, when the extensible/retractable arm unit 11 is in an extended state, the tip end portion of the sensor unit 12c can intersect the front lateral end portion of the workpiece W and so that, when the extensible/retractable arm unit 11 is in a retracted state, the tip end portion of the sensor unit 12c can intersect the right or left lateral end portion of the workpiece W. Even in a case where there are provided at least two rotational deviation sensors 12d, the sensor unit 12c may be arranged adjacent to the left end prong 12b.

As described above, the robot (substrate transfer robot) according to the present embodiment includes the extensible/retractable arm unit, the hand (robot hand) and the sensor unit. The extensible/retractable arm unit extends and retracts in the horizontal direction. The hand is provided with the prongs for holding the workpiece (substrate). The base end portion of the hand is rotatably connected to the tip end portion of the extensible/retractable arm unit. The sensor unit is arranged to be rotated by a rotating force of the robot hand. The sensor unit is configured to, when rotated, intersect the lateral end portion of the workpiece held by the prongs when seen in a plan view and to detect the lateral end position of the workpiece.

According to the robot of the aforementioned embodiment, it is possible to make the cost-effectiveness compatible with the securing of the detection accuracy of the position of the workpiece.

While the dual-arm robot has been described by way of example in the aforementioned embodiment, this is not intended to limit the number of arms of the robot. The present disclosure may be applied to a single arm robot or a robot having three or more arms.

In the aforementioned embodiment, the robot is installed on the running carriage to perform the running axis operation. However, the kind of the running mechanism is not limited as long as the robot can move along a predetermined track.

In the aforementioned embodiment, there has been described by way of example a case where the transfer target object is a glass substrate. However, the transfer target object is not limited to the glass substrate but may be a semiconductor wafer or other thin plate-shaped substrates.

The detailed shapes of the respective members may differ from the shapes shown in the drawings of the subject application. The respective components appearing in the embodiment and the modified examples described above may be combined appropriately as long as no conflict arises.

Other effects and modified examples can be readily derived by those skilled in the relevant art. For that reason, the broad aspect of the present disclosure is not limited to the specific disclosure and the representative embodiment shown and described above. Accordingly, the present disclosure can be modified in many different forms without departing from the spirit and scope of the disclosure defined by the appended claims and the equivalents thereof.

What is claimed is:

1. A substrate transfer robot, comprising:
an extensible/retractable arm unit configured to extend and retract in a horizontal direction;
a robot hand provided with prongs for holding a substrate, the robot hand including a base end portion rotatably connected to a tip end portion of the extensible/retractable arm unit; and
a sensor unit arranged to be rotated by a rotating force of the robot hand, the sensor unit configured to, when rotated, intersect a lateral end portion of the substrate held by the prongs when seen in a plan view and to detect a lateral end position of the substrate.

2. The robot of claim 1, wherein the sensor unit is provided at a frame of the robot hand.

3. The robot of claim 2, wherein the rotating force of the robot hand is transmitted to the sensor unit via a power transmission mechanism connected to a rotating shaft of the robot hand.

4. The robot of claim 3, wherein the power transmission mechanism is arranged within the frame of the robot hand.

5. The robot of claim 4, wherein the power transmission mechanism includes a pulley connected to the rotating shaft of the robot hand and a belt wound around the pulley.

6. The robot of claim 5, wherein the sensor unit includes a base end portion rotatably connected to the frame of the robot hand and a rotating shaft provided with a driven pulley having a predetermined pulley ratio with respect to the pulley connected to the rotating shaft of the robot hand, the driven pulley configured to receive the rotating force of the robot hand transmitted through the belt, the sensor unit arranged to rotate in response to the rotation of the robot hand when the robot hand is rotated with respect to the extensible/retractable arm unit.

7. The robot of claim 6, wherein the sensor unit is configured to make arc-like rotation such that, while the extensible/retractable arm unit is extended, a tip end portion of the sensor unit escapes toward the base end portion of the robot hand and such that, while the extensible/retractable arm unit is retracted, the tip end portion of the sensor unit intersects the lateral end portion of the substrate.

8. The robot of claim 6, wherein the sensor unit is configured to make arc-like rotation such that, while the extensible/retractable arm unit is extended, a tip end portion of the sensor unit intersects a front lateral end portion of the substrate and such that, while the extensible/retractable arm unit is retracted, the tip end portion of the sensor unit intersects a right or left lateral end portion of the substrate.

9. The robot of claim 6, wherein a rotation amount of the sensor unit is restricted by the predetermined pulley ratio.

10. The robot of claim 7, wherein a rotation amount of the sensor unit is restricted by the predetermined pulley ratio.

11. The robot of claim 8, wherein a rotation amount of the sensor unit is restricted by the predetermined pulley ratio.

12. The robot of claim 1, wherein the extensible/retractable arm unit includes a first arm having a base end portion rotatably connected to an arm base, and a second arm having a base end portion rotatably connected to a tip end portion of the first arm and a tip end portion to which the robot hand is rotatably connected, the first arm configured to rotate by a rotation amount θ, the second arm configured to rotate in a direction opposite to a rotation direction of the first arm by a rotation amount 2θ twice as large as the rotation amount θ, the robot hand configured to rotate in a direction opposite to a rotation direction of the second arm by a rotation amount θ, whereby the extensible/retractable arm unit extends and retracts while keeping the robot hand in a predetermined orientation.

13. The robot of claim 1, wherein the sensor unit is configured to rotate in response to the rotation of the robot hand caused by a retracting operation of the extensible/retractable arm unit and to detect the lateral end position of the substrate as the tip end potion of the sensor unit intersects the lateral end portion of the substrate when seen in a plan view, and wherein a deviation amount of the substrate is calculated based on the detected lateral end position during a time period between the time at which the lateral end position of the substrate is detected by the sensor unit and the time at which the substrate is transferred to a transfer destination.

14. The robot of claim 13, further comprising:
a rotational deviation sensor configured to detect a rotational deviation of the substrate within a cassette when the prongs enter the cassette in which the substrate is accommodated,
wherein the substrate is held on the prongs by performing a swing axis operation and a running axis operation pursuant to the rotational deviation detected by the rotational deviation sensor and consequently correcting the position of the prongs with respect to the substrate, and the substrate is released in a target position of a transfer destination by correcting the position of the substrate using a deviation amount of the substrate calculated based on the lateral end position of the substrate detected by the sensor unit.

15. A substrate transfer method, comprising:
a first detection step for detecting a rotational deviation of a substrate within a cassette when prongs enter the cassette in which the substrate is accommodated;
a first correction step for causing the substrate to be held on the prongs by performing a swing axis operation and a running axis operation pursuant to the rotational deviation detected in the first detection step and consequently correcting the position of the prongs with respect to the substrate;
a second detection step for detecting a lateral end position of the substrate by causing a sensor unit to rotate in response to the rotation of a robot hand including the prongs when the prongs holding the substrate are moved out of the cassette and causing the sensor unit to intersect a lateral end portion of the substrate when seen in a plan view; and
a second correction step for releasing the substrate in a target position of a transfer destination by correcting the position of the substrate using a deviation amount of the substrate calculated based on the lateral end position of the substrate detected in the second detection step.
